(19) United States
(12) Patent Application Publication
(10) Pub. No.: US 2018/0245624 A1
(43) Pub. Date: Aug. 30, 2018

(54) PROTECTIVE CAP, BALL JOINT COMPRISING A PROTECTIVE CAP OF THIS TYPE AND TWO-POINT LINKAGE COMPRISING A BALL JOINT OF THIS TYPE

(71) Applicant: ZF Friedrichshafen AG, Friedrichshafen (DE)

(72) Inventors: Günter REDDEHASE, Brockum (DE); Janina ALTMEPPEN, Georgsmarienhütte (DE)

(21) Appl. No.: 15/756,250

(22) PCT Filed: Aug. 9, 2016
(86) PCT No.: PCT/EP2016/068934

§ 371 Date: Feb. 28, 2018

(30) Foreign Application Priority Data
Sep. 9, 2015 (DE) 102015217217.1

(51) Int. Cl. F16C 11/06

(52) U.S. Cl. CPC F16C 11/0671; F16C 2326/24; F16C 2202/24; F16C 11/0633

(57) ABSTRACT

A protective cap (1, 30) for covering some areas of a fully assembled ball joint (50). The protective cap (1, 30) can be screwed, by virtue of a multi-turn, all-round internal thread (11), onto a threaded section (53) of a ball stud (51) of the ball joint (50). Furthermore, a ball joint (50) with a ball stud (51) having a protective cap (1, 30) screwed onto a threaded section (53) of the ball stud (51). Also a two-point linkage (80) with at least one ball joint (81, 82) having a ball stud (51) with a protective cap. The linkage is in the form of a steering rod (80), a track rod, a stabilizer tie-rod, an operating link or a Panhard rod.

This application is a National Stage completion of PCT/EP2016/068934 filed Aug. 9, 2016, which claims priority from German patent application serial no. 10 2015 217 217.1 filed Sep. 9, 2015.

### FIELD OF THE INVENTION

The invention concerns a protective cap, a ball joint with such a protective cap and a two-point linkage with such a ball.

### BACKGROUND OF THE INVENTION

Protective caps for covering some areas of fully assembled ball joints are known from the prior art. DE 102 42 578 A1 describes a protective cap which can be fitted in the axial direction onto a ball stud of a fully assembled ball joint and, to release the ball stud, can be taken off it again. The inside contour of the protective cap has at least one elastic tongue projecting radially inward. When the protective cap is fitted onto the ball stud, the elastic tongue engages in an external thread of a threaded section of the ball stud. In an all-round design, in contrast to the helically extending thread turns of a thread the elastic tongue is closed in on itself. The elastic tongue is arranged in a plane that extends perpendicularly to the centerline of the protective cap. Consequently the engagement of the elastic tongue in the external thread of the threaded section is not completely interlocked, because the elastic tongue does not have a pitch in the manner of the external thread. For that reason, when the protective cap is being fitted on, the protective cap may tilt relative to the ball stud if the centerlines of the threaded stud and the protective cap are not coincident.

Due to the elasticity of the tongue, exactly precise positioning of the protective cap in the axial direction of the ball stud is not ensured. When the force required for fitting on is removed, by virtue of its elasticity the tongue can be retracted into a thread turn of the external thread if it has not yet over-ridden the thread peak to an adjacent thread, or the tongue can unintentionally be caught in a thread turn whose thread peak it has just over-ridden. When the protective cap is fitted on, an all-round gap is formed between a conical section of the ball stud and the inside circumferential surface of the protective cap. During the fitting of the protective cap onto the ball stud, at the same time a front end of a sealing bellows of the ball joint is pushed in the axial direction of the ball stud. During this an inside circumferential surface of the front end of the sealing bellows is pressed against the ball stud in the area of a contact surface between the conical section of the ball stud and the aforesaid inside circumferential surface. When the force required for fitting on the protective cap has been removed, then depending on the position that the elastic tongue happens by chance to be in relative to the external thread of the ball stud, this pressure force can vary. Thus, a repeatedly accurate adjustment of the pressure force is not possible. Owing to the elastic structure of the tongue there is a limit on the force with which, when the protective cap has been successfully fitted on, the front end of the sealing bellows can be held in its position pushed in the axial direction. The protective cap is open at both ends and when fitted in place, completely covers a sealing bellows of the ball joint. The outer circumference of the protective cap is of circular shape over its full length.

### SUMMARY OF THE INVENTION

The purpose of the present invention is to provide a protective cap that enables exact and repeatedly accurate positioning relative to a ball stud of a ready-assembled ball joint.

According to the present invention this objective is achieved by a protective cap of the type concerned which also embodies the characterizing features specified in the independent claims.

Preferred embodiments and further developments are the object of the subordinate claims.

Accordingly, the invention envisions a protective cap for covering some areas of a fully assembled ball joint. According to the invention, the protective cap can be screwed by virtue of an all-round internal thread with a plurality of turns onto a threaded section of a ball stud of the ball joint.

In the context of the present invention a fully assembled ball joint is understood to mean a ball joint which is functional and ready for fitting in a vehicle. The ball stud has at one end a joint ball by means of which the ball stud is fitted and able to rotate and pivot in a housing of the ball joint. The threaded section is preferably arranged on the end of the ball stud opposite to the joint ball and has an external thread shaped to fit the internal thread of the protective cap. The internal thread is preferably a fine-pitch thread, in particular a metric fine-pitch thread according to DIN 13. For example, a fine-pitch thread with an outer diameter of 24 millimeters and a thread pitch from one turn to the next turn of 1.5 millimeters can be used. Fine-pitch threads have the advantage that having a pitch smaller compared with regular threads, they act in a self-locking manner so that a spontaneous loosening of the protective cap from the threaded stud is prevented. Due to the relatively small pitch, when fine-pitch threads are used a relatively large rotational movement during the screwing-on of the protective cap produces only a relatively small movement in the axial direction. Thus, the use of a protective cap with a fine-pitch thread enables fine adjustment which makes it possible to achieve an exact and repeatedly accurate positioning of the protective cap on the ball stud. In the context of the invention an internal thread with a plurality of turns is understood to mean a thread having a pitch, whose thread turns extend helically over more than a complete rotation. Preferably the internal thread formed in the protective cap extends over about 1.5 rotations and therefore has more than one turn, covering an angle of 540 degrees.

In contrast to the elastic tongues described earlier and known from the prior art, the thread turns are not flexible. Moreover, the thread turns preferably run round uninterruptedly. In this way a maximum possible engagement interlock is produced between the thread contours of the internal thread of the protective cap and the external thread of the ball stud when the protective cap is screwed on. This results in an exact positioning of the protective cap relative to the ball stud and prevents tilting of the two components relative to one another. The protective cap preferably has a right-hand thread because the corresponding thread of the ball stud is also preferably provided with a right-hand thread. The protective cap is preferably made from plastic integrally, as one piece. Advantageously, the protective cap is produced by the plastic injection-molding method. After its intended use the protective cap retains the same geometrical and material properties as before it was used, so it can be used repeatedly.

Preferably, the protective cap is produced by injection molding. Accordingly, by the nature of the process the protective cap will have mold parting burrs as are commonly found on workpieces at the junction of the two mold halves of an injection molding die. The mold parting burrs can extend in a common plane with the centerline of the protective cap. In that case the protective cap is preferably made symmetrical as far as its internal thread, relative to a plane coincident with the mold parting burrs. Alternatively, the protective cap can have mold parting burrs lying in a plane that extends perpendicularly to the centerline of the protective cap.

According to a further development of the invention, the outer circumference of the protective cap has at least one geometrical feature that can be gripped, which is suitable for the interlocking application of a torque acting in the direction of the outer circumference. By virtue of this grippable geometry the outer circumference of the protective cap deviates from circularity, at least in some areas. The grippable geometry serves to enable interlocked transmission of the torque required in order to screw the protective cap onto the ball stud by hand or with the help of a tool. The interlocked transmission of the torque has the advantage that it does not depend on the condition of the outer circumferential surface of the protective cap. For example, if the outer circumferential surface of the protective cap is dirtied with oil, this has no adverse effect on the transmission of torque when that is done with interlock. In contrast, if the torque were transmitted exclusively by friction, then an oil-contaminated outer circumferential surface could result in slipping of the protective cap relative to the means used to transmit the torque.

Advantageously, the grippable geometry is in the form of a regular polyhedron or at least one wing. The regular polyhedron is in particular in the form of a double hexagon. With such a design the torque required for screwing the protective cap on and off can be applied with a commonly available socket wrench. Alternatively, for example automated screwing tools such as a cordless screwdriver with a shape-matching set of attachments can be used. The polygonal geometrical feature is preferably located at one axial end of the protective cap so that it can be accessed easily by a screwing tool. Furthermore, an arrangement of the polygonal geometry at the end makes it easy to fit a screwing tool over and all round the polygon. The at least one wing is arranged on the outer circumference of the protective cap, extending radially outward. The protective cap preferably has two radially opposite wings, the term “wing” being intended to indicate a similarity with a wing nut. The wings are provided for screwing the protective cap onto the ball stud or off it manually if no suitable screwing tool is at hand or if the polygonal geometry has been damaged or is not accessible. It has been found advantageous to provide on the protective cap a polygonal geometry and at the same time wings as well, so that regardless of the presence or absence of properly fitting screwing tools the protective cap can in any case be screwed on or off.

Preferably, in order to increase its rigidity the protective cap is reinforced in some areas by at least one rib structure. In the context of the invention a rib structure is understood to mean an arrangement of individual reinforcing ribs associated with a wall of the protective cap and distributed substantially uniformly around the circumference of the wall. The ribs of the rib structure are preferably formed integrally with the wall. The rib structure can be arranged only on an inside, or only on an outside of the wall, or both on the inside and on the outside of the wall. The individual ribs of the rib structure can extend in the axial direction and/or in the circumferential direction of the protective cap. If the ribs extend in the axial direction of the protective cap, they are preferably arranged in the axial direction at the same level. The inside and/or the outside of the wall can in each case have more than one rib structure. The at least one rib structure increases the rigidity of the wall of the protective cap for covering some areas of the fully assembled ball joint, and thus improves the protection of the covered parts of the ball joint against mechanical damage.

Advantageously, to improve its heat-insulating effect the protective cap is made double-walled in some areas. For this, in some areas the protective cap has an additional wall a distance away from its wall, which in particular is arranged concentrically with the wall of the protective cap. Preferably, the wall of the protective cap is enclosed by the additional wall. In such a case the connection between the wall of the protective cap and the additional wall is formed by a fin structure preferably extending in the axial direction of the protective cap and arranged between the wall of the protective cap and the additional wall. The fin structure is preferably made integrally both with the wall of the protective cap and with the additional wall. In particular, the fins of the fin structure occupy only a small part of the intermediate space between the wall of the protective cap and the additional wall; most of that intermediate space is filled with air. Since as is known air is a good heat insulator, when exposed to heat, for example radiant heat, the fully assembled ball joint is protected effectively against damage by the partially double-walled structure of the protective cap. The additional wall is preferably arranged between the wall of the protective cap and the heat source, so that the heat given off by the heat source encounters the additional wall first and the wall of the protective cap is protected thereby.

In an advantageous embodiment of the invention the protective cap has a first sealing surface extending perpendicularly to its centerline and radially all round, to make contact with a sealing bellows of the ball joint. The first sealing surface is preferably an annular surface. The annular surface can be interrupted by a radially circumferential recess which, when the protective cap is produced by the plastic injection molding process, may be necessary in order to produce the most uniform possible wall thicknesses and to avoid accumulation of the material. In that case the first sealing surface is divided into two radially separated, concentrically arranged annular surfaces. By virtue of the first sealing surface an unwanted penetration of media, especially liquid media, at least into some of the areas of the fully assembled ball joint covered by the protective cap, is avoided.

According to a further development of the invention, on its inside circumferential surface the protective cap has a radially all-round second sealing surface, to make contact with the ball stud. In particular the second sealing surface is arranged at one free end of the inside circumferential surface and is directly adjacent to the first sealing surface. In an axial section through the centerline of the protective cap the first sealing surface and the second sealing surface preferably enclose an angle of 90 degrees. In its undeformed condition the second sealing surface is in particular in the form of an outer surface of a cylinder, whose centerline coincides with the centerline of the protective cap and extends in the axial direction of the protective cap. The relatively small axial extension of the second sealing surface, for example one millimeter, at the same time forms a first contact surface with a conical section of the ball stud described earlier. During the fitting of the protective cap, in its undeformed condition the second sealing surface first makes contact with the conical section over an all-round continuous line, which is in particular a circular line and is arranged at the aforesaid free end of the inside circumferential surface. When the protective cap is screwed on this is displaced relative to the ball stud in the axial direction. During this displacement the diameter of the conical section increases steadily as the screwing-on continues.

Since the second sealing surface is in the form of an outer surface of a cylinder, as the screwing-on of the protective cap continues, all-round surface contact is produced between the conical section of the ball stud and the second sealing surface of the protective cap. During this the second sealing surface, which in the undeformed condition is in the form of an outer surface of a cylinder, is deformed slightly until ultimately it rests in contact all over its surface against the conical section of the ball stud. In that way the second sealing surface provides further protection against the unwanted penetration of media, especially liquid media with a corrosive action, into at least some of the areas of the fully assembled ball joint covered by the protective cap.

Preferably, the second sealing surface forms an end-stop for the screwing of the protective cap onto the ball stud. When the second sealing surface is in contact with the ball stud all round its circumference, the protective cap cannot be screwed down any farther. In that way the second sealing surface forms an end-stop for the screwing-on of the protective cap. Thus, the second sealing surface functions as a sealing surface and at the same time as a stop surface. Owing to the previously described fine-pitch connection between the external thread of the ball stud and the internal thread of the protective cap, when the protective cap is screwed onto the ball stud, with a relatively low torque a relatively high sealing force can be produced at the end-stop position. Thus, the protective cap can be screwed on by hand even without additional tools. Once while screwing on the protective cap the end-stop has been reached and the torque required for screwing on the protective cap is no longer being applied, the protective cap remains in the end-stop position thanks to the self-locking property of the fine-pitch screw connection described earlier.

Advantageously, the protective cap has at least one drainage opening. The at least one drainage opening preferably passes through the wall of the protective cap in an upper section extending between the first sealing surface and an assembly opening of the protective cap. Preferably the protective cap has several drainage openings, which are distributed uniformly around the circumference of the protective cap in an imaginary plane perpendicular to the centerline of the protective cap. Through the assembly opening, which is at one end of the protective cap and preferably has the largest inside diameter of the protective cap, the fully assembled ball joint that the protective cap is to cover is inserted. The central axes of the drainage openings preferably extend parallel or in a plane perpendicular to the centerline of the protective cap. The drainage openings, which are preferably cylindrical, serve to drain away liquid media in particular, such as corrosive cleaning media from surface pretreatment units, that can make their way into the upper section of the protective cap during the production process. Preferably, disregarding the internal thread, the gripping geometry, the fin structures and the drainage openings, the protective cap is rotationally symmetrical.

In an advantageous further development of the invention, in a lower section that extends from the first sealing surface as far as a bottom at the end of the protective cap, the protective cap is made completely closed. The bottom is arranged opposite the assembly opening in the axial direction. When the protective cap is screwed on the completely closed structure of the lower section of the protective cap, in combination with the first and second sealing surfaces, prevent liquid media such as corrosive cleaning media from surface pretreatment units from making their way onto the covered part of the ball stud during the production process. This is particularly advantageous because the ball stud in that area often has a plain metallic surface, only lightly oiled, and is therefore devoid of any, or any particularly effective corrosion protection. In particular the bottom is uninterruptedly continuous and has a uniform wall thickness. The invention also includes the use of a protective cap as described above for protection during assembly, painting, transport, or for protection against heat. These various possible uses enable one and the same protective cap to be used during the assembly of the ball joint, once by screwing on to cover parts of a fully assembled ball joint, and then, when screwed on during assembly, by leaving it in place during subsequent surface treatment units with pretreatment stages and painting stages, and thereafter as transport protection during shipping to the customer. This is economically very advantageous compared with the use of separate protective caps for individual production or transport stages and the handling effort and cost associated with each. If the protective cap is made double-walled in some areas in order to improve heat insulation, it can also be used as a protective cap against heat.

The invention further proposes a ball joint with a ball stud, wherein a protective cap as described above is screwed onto a threaded section of the ball stud. The ball joint is in particular a fully assembled ball joint which is functional and ready to fit in a vehicle. As already explained, the threaded section of the ball stud, which is preferably made of steel, has an external thread. The longitudinal extension of the external thread in the direction of the central axis of the ball stud is greater than the longitudinal extension of the internal thread of the protective cap in the same direction. The inside diameter of the area of the protective cap that surrounds the external thread but is not part of the internal thread, is preferably 0.1 to 0.7 millimeters larger than the outer diameter of the external thread of the threaded section. This relatively close guiding ensures that the protective cap cannot tilt while it is being screwed onto the threaded section of the ball stud. When the protective cap has been screwed on, the inside of the bottom of the protective cap is preferably a distance away from the opposite end of the ball stud. This clearance ensures that the second sealing surface can form an end-stop for screwing the protective cap onto the ball stud. In that way an exact and repeatedly accurate positioning of the protective cap relative to the ball stud of the fully assembled ball joint is made possible. The repeated accuracy when screwing on the protective cap can be increased still more with a device for pre-setting the tightening torque to be applied.

In an advantageous embodiment the ball joint has a sealing bellows, such that the screwed-on protective cap leaves clear part of the sealing bellows. The sealing bellows is preferably of rotationally symmetrical design and is attached at an end section to a housing of the ball joint by means of a clamping ring. This end section of the sealing bellows, together with the clamping ring, are not covered by the protective cap, so that during a painting step the clamping ring can be provided with additional surface protection without having to unscrew the protective cap for that. In particular, the housing of the ball joint is made integrally with a shaft for connecting the ball joint to a connecting tube of a two-point linkage. The shaft can have a partially surrounding serrated contour for connecting the ball joint to the connecting tube, or an external thread for the adjustable connection of the ball joint to the connecting tube.

According to a further development of the invention, when the protective cap is screwed on, the sealing bellows is held in its fitted position by the protective cap, in particular by the first sealing surface of the protective cap. As described earlier, the ball stud has a conical section which tapers in the direction of the threaded section. In contact with the outer circumference of this conical section there is a lower end section of the sealing bellows, which lower end section is opposite the end section of the sealing bellows clamped to the housing. The inside wall of the lower end section is in contact with the conical section of the ball stud, forming a second contact surface. The first sealing surface of the protective cap is in contact with an end surface of the lower end section of the sealing bellows, forming a third contact surface, and the end surface can comprise a labyrinth seal. The first contact surface already described earlier, over which the second sealing surface rests in contact with the outer circumference of the conical section of the ball stud, forming a seal, is adjacent to the second contact surface and is essentially arranged as an extension thereof. The first and second contact surfaces are arranged at least substantially perpendicularly to the third contact surface, so that respectively an end of the first, second and third contact surfaces meet at a point.

The sealing bellows is held in its fitted position by the first sealing surface. This means that the lower end section of the sealing bellows, when the protective cap is screwed on, is pressed by the first sealing surface in the axial direction toward the widening-out conical section of the ball stud in order in that way to simulate the position of the lower end section of the sealing bellows in the later, fitted condition in the vehicle. If the protective cap were to be unscrewed again, the lower end section of the sealing bellows would be released and would move in the direction toward the tapering down part of the conical section of the ball stud. This would break the contact between the inside wall of the lower end section of the sealing bellows and the conical section of the ball stud over the second contact surface and an all-round gap would be produced at that point, into which moisture in particular could penetrate, which would in all probability result in premature failure of the ball joint during driving operation. The part of the conical section projecting out of the sealing bellows and the threaded section of the ball stud are in particular made with plain metal or only lightly greased surfaces. To protect these surfaces against corrosion, in particular caused by contact with corrosively acting liquid media, the protective cap is made completely closed between the first sealing surface and the bottom.

The invention also proposes a two-point linkage having at least one ball joint as described above. The two-point linkage is characterized in that it is designed as a steering rod, a track rod, a stabilizer tie-rod, an operating link or a Panhard rod. In particular the two-point linkage has at each of its two ends a ball joint with a protective cap as described earlier. During the transport of such two-point linkages, which are often quite unwieldy, there is a high risk of mechanical damage to the ball joints arranged at the ends. By virtue of the at least one rib structure described earlier, the protective cap offers extensive protection against mechanical damage to the areas of the fully assembled ball joint covered by the protective cap. Furthermore, thanks to the protective cap screwed onto the ball stud the risk of injury during the transport of the two-point linkage is reduced, because the external thread of the ball stud is covered.

During the assembly of the ball joint, the protective cap is screwed onto the ball stud and remains there even during the fitting of the two-point linkage onto the ball stud. Thereafter the completed two-point linkage, preferably suspended, passes through a pretreatment unit in which the complete surface of the two-point linkage including the ball joints fitted at its ends is treated partially under high pressure with aqueous cleaning and degreasing media. This is followed by rinsing processes and water-based phosphating. During this the previously described seals in the areas of the first, second and third contact surfaces offer reliable protection against the penetration of the above-mentioned liquid media onto the plain or only lightly greased surfaces of the ball stud. Aqueous media that have collected in the upper section of the protective cap during the pretreatment of the two-point linkage can drain away through the drainage openings. During the subsequent spray-painting the upper section of the protective cap offers substantial protection against a precipitation of the spray mist onto the sealing bellows. Preferably, the protective cap also remains in place on the ball stud during preparation for dispatch and during the subsequent transport to the customer. Here, again the completely closed lower section of the protective cap is advantageous because, for example, it protects the ball studs against corrosive sea air during transport by ship. The protective cap is screwed off again only immediately before fitting the two-point linkage into a vehicle such as a truck or a bus.

### BRIEF DESCRIPTION OF THE DRAWINGS

Below, the invention is explained in more detail with reference to drawings that illustrate embodiments presented only as examples. The same indexes refer to the same components or elements in the drawings, which show:

FIG. 1: A perspective view of a protective cap according to a first embodiment of the invention;

FIG. 2: A sectioned view of the protective cap shown in FIG. 1;

FIG. 3a: An enlarged view of the detail X in FIG. 2, in which the protective cap is rotated slightly about the central axis;

FIG. 3b: A detailed view as in FIG. 3a, supplemented by a ball stud;

FIG. 4: A perspective view of a protective cap according to a second embodiment of the invention;

FIG. 5: A sectioned view of a ball joint with a protective cap according to the first embodiment;

FIG. 6: An enlarged view of the detail Y in FIG. 5;

FIG. 7: A partially sectioned view of a two-point linkage with ball joints arranged at its ends.

### DETAILED DESCRIPTION OF THE PREFERRED EMBODIMENTS

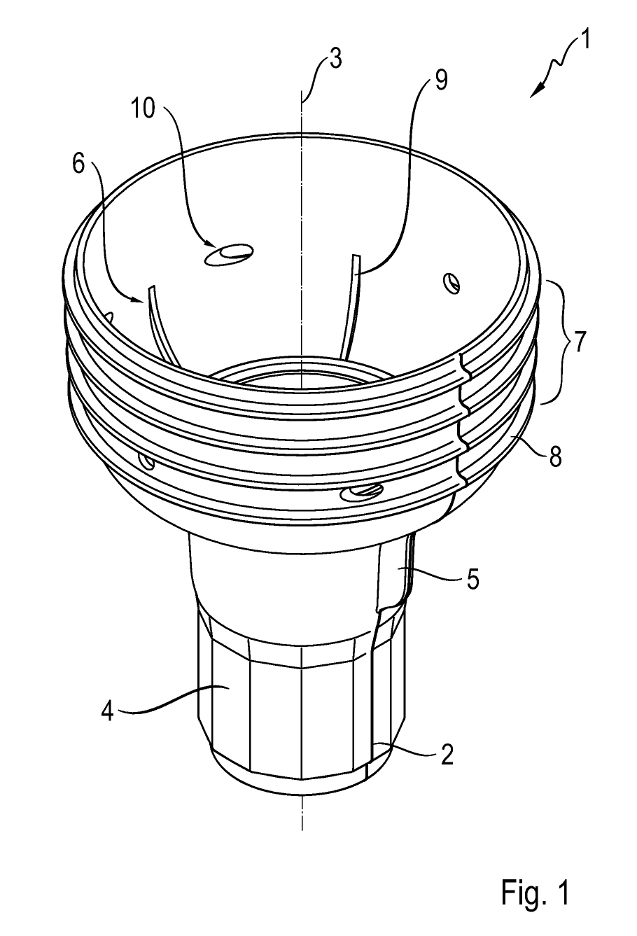

FIG. 1 shows a first embodiment of an integrally formed protective cap 1, made of plastic by a plastic injection-molding process. By the nature of the process the protective cap 1 has mold-parting burrs 2 that extend in a common plane with the centerline 3 of the protective cap 1. To facilitate the interlocked application of a torque acting in the direction of the outer circumference of the protective cap 1, the protective cap has a grip-enabling geometry in the form of a regular polygon, in this case a double hexagon 4, and a pair of radially opposed wings 5, one of which wings is not visible in the figure. The double hexagonal gripping geometry 4 is provided for the screwing on and off of the protective cap 1 using a screwing tool and the wings 5 for screwing it on and off by hand. To increase its rigidity the protective cap is reinforced by two rib structures 6, 7, each of the rib structures 6, 7 being formed by a plurality of individual ribs 8, 9. For use in a pretreatment unit that works with water-based cleaning and rinsing media, and in a phosphating unit, the protective cap 1 is provided with a number of drainage openings 10 which allow liquid media to drain away during the production process.

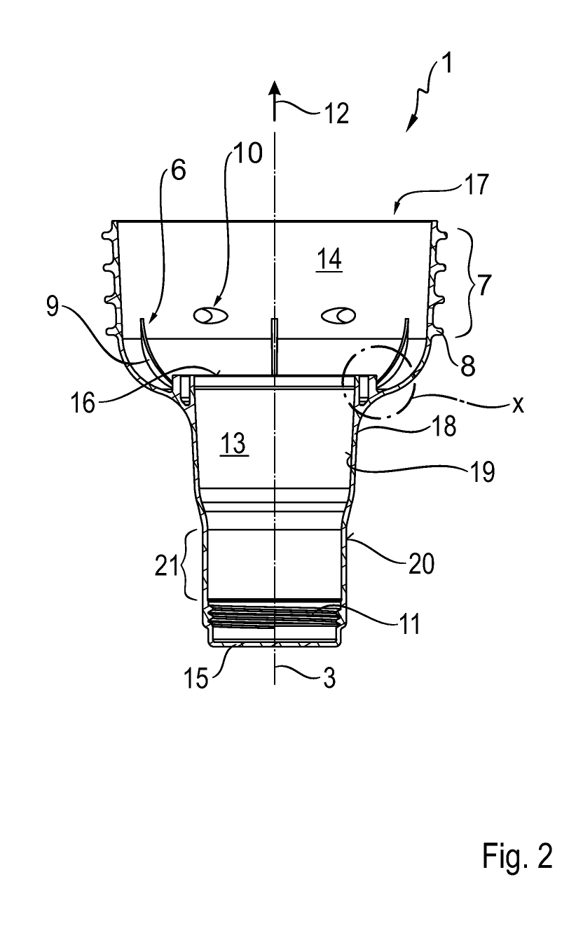

In FIG. 2 it can be seen that the protective cap 1 has a multi-turn internal thread 11. The internal thread 11 is a right-hand, fine-pitch thread formed to go round without interruption over about 1.5 thread pitches. In the axial direction 12 of the protective cap 1 a lower section 13 in which the internal thread is located is attached to an upper section 14 of the protective cap. The lower section 13, which is completely closed, has a bottom 15 at an end of the protective cap 1. The upper section 14, which is separated from the lower section 13 by a first sealing surface 16, has an assembly opening 17 at its end in the axial direction 12 and opposite the bottom 15. The protective cap 1, shaped overall like a cup with a surrounding wall 18, has in its upper section 14 the drainage openings 10 that pass through the wall 18, which are distributed uniformly around the circumference of the protective cap. The upper section 14 is reinforced on the inside circumferential surface 19 of its wall 18 by the rib structure 6 formed of a plurality of ribs 9 distributed uniformly around the circumference and extending in the axial direction 12, the ribs 9 being formed integrally with the wall 18. Furthermore the upper section 14, whose diameter is larger than that of the lower section 13, is also reinforced by a further rib structure 7. This further rib structure 7 is formed of a plurality of ribs 8 arranged on the outer circumferential surface 20 of the wall 18 and connected integrally thereto. The ribs 8 extend in the circumferential direction all round the protective cap 1 and are arranged in parallel planes a distance apart which extend perpendicularly to the centerline 3 of the protective cap 1. On the side of the bottom 15 opposite the internal thread 11 the lower section has a hollow-cylindrical section 21 whose inside diameter is around 0.3 millimeters larger than the outer diameter of the internal thread 11.

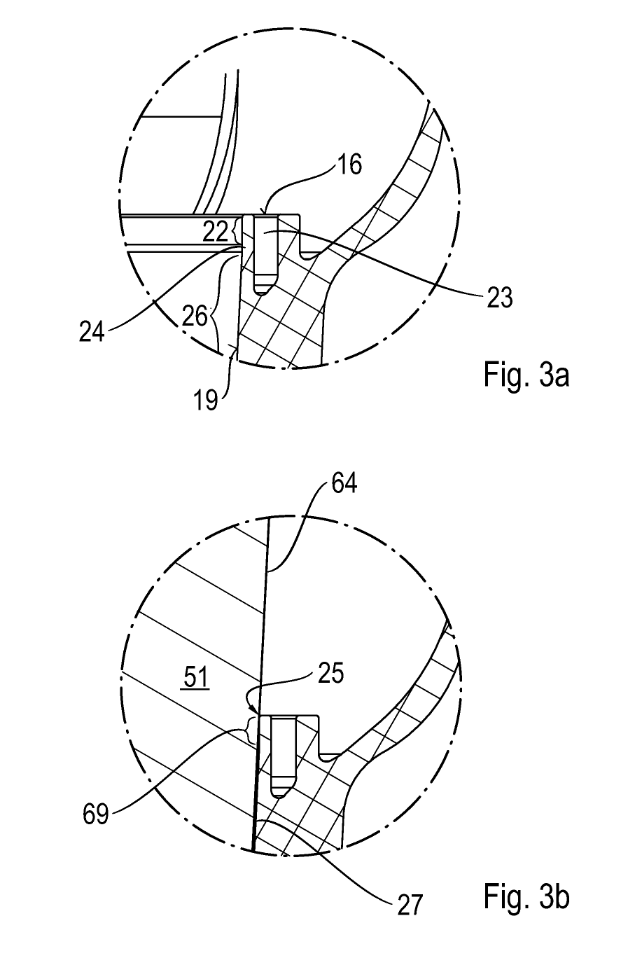

In FIG. 3a it can be seen that at one free end of the inner circumferential surface 19 there is arranged a second sealing surface 22 which extends radially all the way round. The first sealing surface 16 is in the form of a circular ring surface interrupted by a radial all-round recess 23. Thus, the first sealing surface 16 is divided into two concentrically arranged circular ring surfaces a distance away from one another. The innermost of these two circular ring surfaces is part of an annular all-round web 24 which is an integral part of the protective cap 1 and is arranged between the inner circumferential surface 19 and the recess 23. Owing to its relatively small wall thickness of 0.8 millimeters in the area of the second sealing surface 22, the web 24 has some elasticity. Thanks to that, the second sealing surface 22, which is also part of the surface of the web 24, can fit very snugly to form a seal against a ball stud 51 close to it in the assembled condition. In the axial extension of the inner circumferential surface 19 of the protective cap 1 a conical section 26 is adjacent to the second sealing surface 22, separated therefrom by a transition radius.

For the sake of clarity FIG. 3b shows the arrangement already illustrated in FIG. 3a, supplemented by the ball stud 51. The second sealing surface 22, whose axial extension of one millimeter is relatively small, at the same time forms a first contact surface 69 with a conical section 64 of the ball stud 51. During the fitting of the protective cap 1 this is displaced relative to the ball stud 51 by being screwed onto the ball stud 51. During this the at first still undeformed second sealing surface 22 of the protective cap 1 comes into contact with the conical section 64 initially with the free end of the inner circumferential surface 19 in an all-round line contact in the form of a circular line 25. As the screwing on continues, the diameter of the conical section 64 of the ball stud 51 continually increases. Since the second sealing surface 22 is in the form of an outer surface of a cylinder with a certain elasticity, as the screwing on continues an all-round surface contact is formed between the second sealing surface 22 of the protective cap 1 and the conical section 64 of the ball stud 51. During this the second sealing surface 22, which in the undeformed condition was in the form of a cylindrical outer surface, is deformed elastically essentially into the shape of an outer surface of a cone which fits in a shape-matching manner against the conical section 64 of the ball stud 51. In this assembled condition the conical section 26 of the protective cap 1 is separated from the conical section 64 of the ball stud 51 by circumferential ring gap 27. Thus, the second sealing surface 22 in contact with the conical section 64 of the ball stud 51 at the same time functions as an end-stop for the screwing of the protective cap 1 onto the ball stud 51. Although the web 24 on the one hand has a certain elasticity which enables the full-area contact of the second sealing surface 22 against the conical section 64 of the ball stud 51, the closed-ring structure of the web 24 results in a minimal flexibility in relation to the function of the second sealing surface 22 as an end-stop.

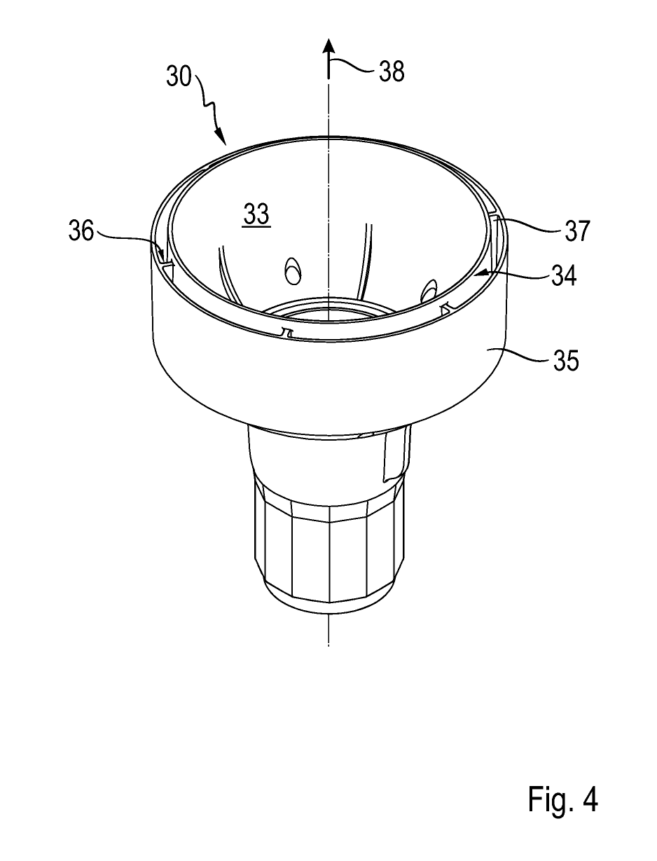

FIG. 4 shows a protective cap 30 according to a second embodiment. In its upper part 33, to improve the heat insulation the wall 34 of the protective cap 30 is surrounded by an additional wall 35 concentrically around and a distance away from the wall 34, this additional wall 35 being in the form of a cylindrical ring. The also cylindrical-ring-shaped intermediate space between the wall 34 and the additional wall 35 is bridged by a fin structure 36 whose fins 37 extend in the axial direction 38 of the protective cap 30 and are distributed uniformly around the circumference. Other details of the structure of the protective cap 30 correspond to the first embodiment, which is described above and illustrated in FIGS. 1 to 3.

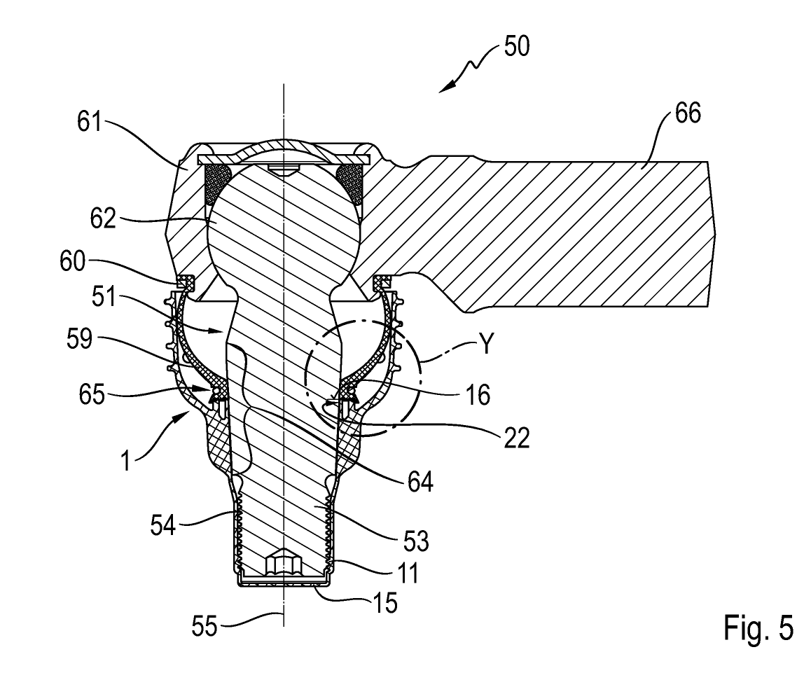

FIG. 5 shows a ball joint 50 in the form of a radial ball joint with the ball stud 51, wherein a protective cap 1 according to the first embodiment as described above is screwed onto a threaded section 53 of the ball stud 51. Alternatively it is also possible to screw a protective cap according to the second embodiment onto the threaded section 53 of the ball stud 51. The ball joint 50 is a fully assembled ball joint, which is functional and ready to be fitted in a vehicle. The threaded section of the ball stud 51 has an external thread 54. The extension of the external thread 54 in the direction of the central axis 55 of the ball joint 51 is larger than the extension of the internal thread 11 of the protective cap 1 in the same direction. The external thread 54 and the internal thread 11 fit one another and form a right-hand, fine-pitch screw connection. The inside diameter of the area of the protective cap 1 which surrounds the external thread 54 but is not part of the internal thread, is 0.3 millimeters larger than the outer diameter of the external thread 54 of the threaded section 53. This relatively close guiding ensures that while the protective cap 1 is being screwed onto the threaded section 53 of the ball stud 51 it cannot tilt. When the protective cap 1 has been screwed on, the inside of the bottom 15 of the protective cap 1 is a distance away from an end of the ball stud 51 opposite it. This clearance ensures that the second sealing surface 22 can form an end-stop for the screwing of the protective cap 1 onto the ball stud 51.

The ball joint 50 has a sealing bellows 59, although the screwed-on protective cap 1 leaves part of the sealing bellows 59 clear. The sealing bellows 59 is designed rotationally symmetrically and is clamped at a section at its front end to a housing 61 of the ball joint 50 by means of a clamping ring 60. This front end section of the sealing bellows 59, and with it the clamping ring 60, are not covered by the protective cap 1, so that during a painting step the clamping ring 60 can be provided with additional surface protection without having to screw off the protective cap 1 to make that possible. At one end, the ball stud 51 has a joint ball 62 which is fitted and able to rotate and pivot in the housing 61 of the ball joint 50. The threaded section 53 is arranged at the end of the ball stud 51 opposite the joint ball 62. The housing 61 of the ball joint 50 is made integrally with a shaft 66 for connecting the ball joint 50 to a connecting tube 83 of a two-point linkage 80.

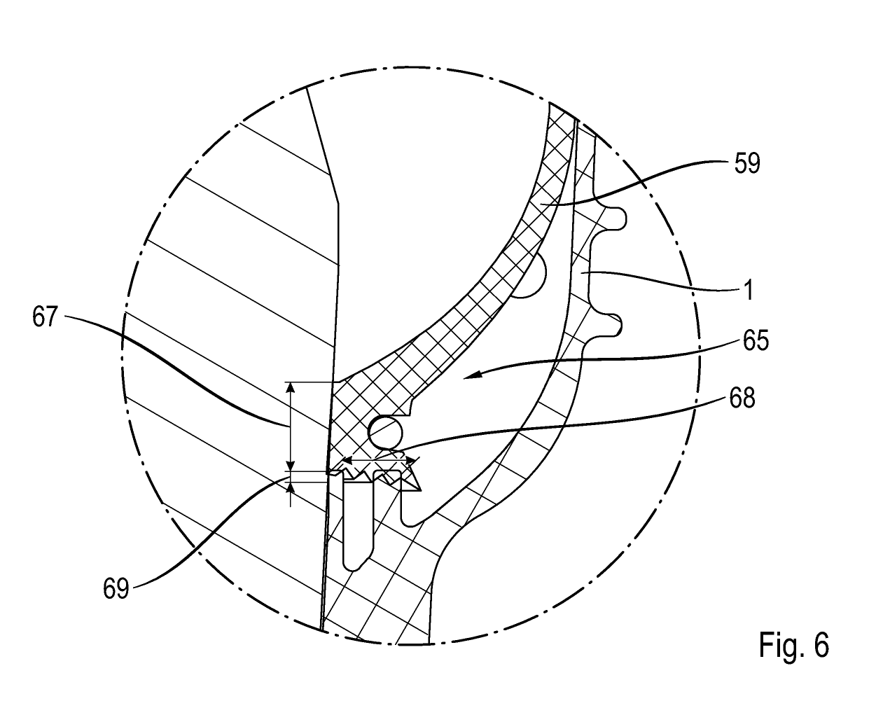

When the protective cap 1 is screwed on, the sealing bellows 59 is held in its fitted position by the protective cap 1, in particular by the first sealing surface 16 thereof. The conical section 64 of the ball stud 51 tapers down in the direction toward the threaded section 53. In contact with the outer circumference of this conical section 64 is a lower end section 65 of the sealing bellows 59, which lower end section 65 is opposite the end section of the sealing bellows 59 clamped to the housing 61. The inside wall of the lower end section 65 is in contact with the conical section 64 of the ball stud 51, forming a second contact surface 67. The first sealing surface 16 of the protective cap 1 is in contact with an end surface of the lower end section 65 of the sealing bellows 59, forming a third contact surface 68. The end surface has a labyrinth seal, which is shown in its slackened condition and which therefore overlaps with the first sealing surface 16. The first contact surface 16, in which the second sealing surface 22 contacts and forms a seal against the outer circumference of the conical section 64 of the ball stud 51, is adjacent to the second contact surface 67 and is arranged essentially as an extension thereof. The first contact surface 69 and the second contact surface 67 are at least substantially perpendicular to the third contact surface 68, so that an end in each case of the first 69, second 67 and third 68 contact surfaces shown in FIG. 6 meet at a point. To protect the surface of the ball stud 51 that projects out of the sealing bellows 59 against corrosion, in particular caused by contact with corrosively acting liquid media, the protective cap 1 is made completely closed between the first sealing surface 16 and the bottom 15.

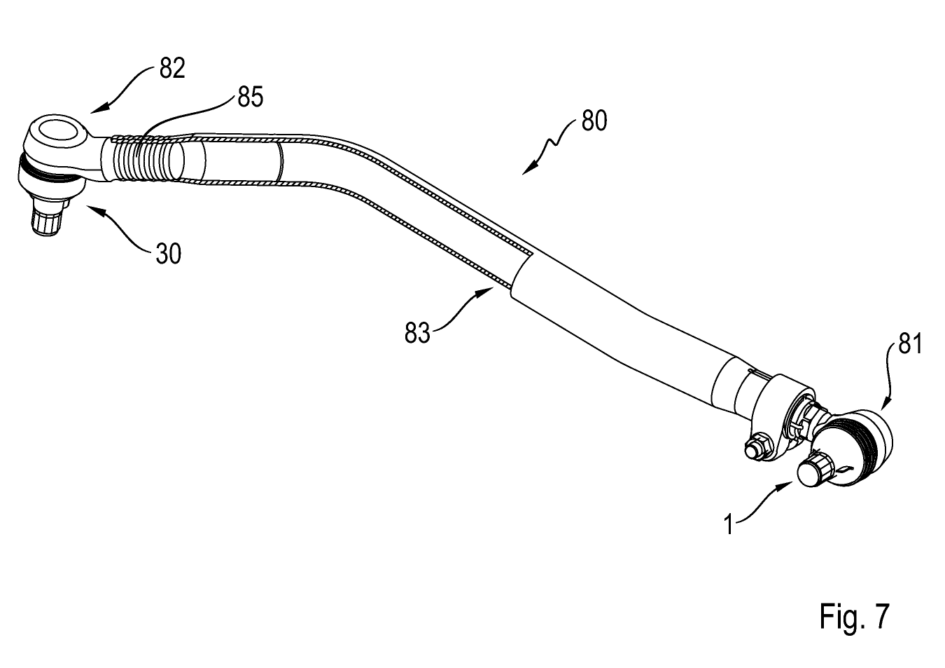

FIG. 7 shows a two-point linkage designed as a steering rod 80, at whose ends two fully assembled ball joints 81, 82 as described above are arranged. The ball joints 81, 82 are connected to one another by means of a connecting tube 83. To cover some parts of it a protective cap 1 according to the first embodiment described previously and illustrated in FIGS. 1 to 3 is screwed onto the first 81 of the two ball joints. The first ball joint 81 has a shaft (only partly visible) with an external thread extending in its longitudinal direction. The second 82 of the two ball joints has a shaft 85 which is connected to the connecting tube 83 by means of a hot swaging process. During the hot swaging the associated end section of the connecting tube 83 is brought into engagement with the serrated structure. In order to protect the second ball joint 82, in particular the sealing bellows 59 (not visible) of the second ball joint 82 against damage due to process-related radiant heat at the joint location during the hot swaging, a heat-insulating protective cap 30 according to the second example embodiment described earlier and illustrated in FIG. 4 is screwed onto the second ball joint 82. The ball joints 81, 82 differ from the previously mentioned ball joint 50 only in the structure of their shaft.

### INDEXES

1 Protective cap
2 Mold-parting burr
3 Centerline
4 Polygon, double hexagon
5 Wing
6 Rib structure
7 Rib structure
8 Rib
9 Rib
10 Drainage opening
11 Internal thread
12 Axial direction
13 Lower section
14 Upper section
15 Bottom
16 First sealing surface
17 Assembly opening
18 Wall
19 Inside circumferential surface
20 Outer circumferential surface
21 Hollow-cylindrical section
22 Second sealing surface
23 Recess
24 Web
25 Linear contact, circular line
26 Conical section
27 Annular gap
30 Protective cap
33 Upper section
34 Wall of the protective cap
35 Additional wall
36 Fin structure
37 Fin
38 Axial direction
50 Ball joint
51 Ball stud
53 Threaded section
54 External thread
55 Central axis
59 Sealing bellows
60 Clamping ring
61 Housing
62 Joint ball
64 Conical section
65 Lower end section
66 Shaft
67 Second contact surface
68 Third contact surface
69 First contact surface
80 Two-point linkage, steering rod
81 First ball joint
82 Second ball joint
83 Connecting tube
85 Shaft

1-13. (canceled)

14. A protective cap (1, 30) for covering some areas of a fully assembled ball joint (50),
the protective cap (1, 30) being screwed, by virtue of a multi-turn all-round internal thread (11), onto a threaded section (53) of a ball stud (51) of the ball joint (50).

15. The protective cap (1, 30) according to claim 14, wherein an outer circumference of the protective cap (1, 30) has at least one grip-enabling geometrical feature (4, 5), which is suitable for the interlocked application of a torque acting in a direction of the outer circumference.

16. The protective cap (1, 30) according to claim 15, wherein the grip-enabling geometrical feature is in the form of at least one of a regular polygon (4) and at least one wing (5).

17. The protective cap (1, 30) according to claim 14, wherein the protective cap (1, 30) is reinforced in some areas by a rib structure (6, 7, 36) to increase rigidity thereof.

18. The protective cap (1, 30) according to claim 14, wherein the protective cap (1, 30) has a radially circumferential first sealing surface (16) that extends perpendicularly to a centerline (3) of the protective cap and which forms a seal against a sealing bellows (59) of the ball joint (50).

19. The protective cap (1, 30) according to claim 14, wherein an inside circumferential surface (19) of the protective cap (1, 30) has a radially circumferential second sealing surface (22) that mates with the ball stud (51).

20. The protective cap (1, 30) according to claim 19, wherein the second sealing surface (22) forms an end-stop for the screwing of the protective cap (1, 30) onto the ball stud (51).

21. The protective cap (1, 30) according to claim 4, wherein the protective cap (1, 30) has at least one drainage opening (10).

22. The protective cap (1, 30) according to claim 18, wherein the protective cap (1, 30) is made completely closed in a lower section (13) of the protective cap, which extends from the first sealing surface (16) down to a bottom (15) at an end of the protective cap (1, 30).

23. A ball joint (50) with a ball stud (51), the ball joint comprising:
a protective cap (1, 30) for covering some areas of a fully assembled ball joint (50), and
the protective cap (1, 30) being screwed by virtue of a multi-turn all-round internal thread (11) onto a threaded section (53) of the ball stud (51) of the ball joint (50).

24. The ball joint (50) according to claim 23, wherein the ball joint (50) has a sealing bellows (59), and the screwed-on protective cap (1, 30) leaves a portion of the sealing bellows (59) exposed.

25. The ball joint (50) according to claim 24, wherein when the protective cap (1, 30) is screwed onto a threaded section (53) of the ball stud, the sealing bellows (59) is held in a fitted position by a first sealing surface (16) of the protective cap (1, 30).

26. A two-point linkage (80) with at least one ball joint (50) having a ball stud (51) and a protective cap (1, 30) for covering some areas of a fully assembled ball joint (50), the protective cap (1, 30) being screwed by virtue of a multi-turn all-round internal thread (11) onto a threaded section (53) of the ball stud (51) of the ball joint (50), and the two-point linkage being one of a steering rod (80), a track rod, a stabilizer tie-rod, an operating link, and a Panhard rod.
